(19) United States
(12) Patent Application Publication
(10) Pub. No.: US 2019/0152007 A1
(43) Pub. Date: May 23, 2019

(54) DRILL SOCKET OFF-SET DRIVE ASSEMBLY

(71) Applicant: Erwin Monroy, Los Angeles, CA (US)

(72) Inventor: Erwin Monroy, Los Angeles, CA (US)

(21) Appl. No.: 16/194,245

(22) Filed: Nov. 16, 2018

Related U.S. Application Data
(60) Provisional application No. 62/588,289, filed on Nov. 17, 2017.

(51) Int. Cl. B23Q 5/04

(52) U.S. Cl. CPC B23Q 5/045; B25B 23/0035

(57) ABSTRACT

A drill socket off-set drive assembly is an adapter for use in an electric drill that provides a right angle drive and an offset drive in one unit that is adapted to use various sized sockets for use on hexagonal fastener heads. A throughhole in the housing aligning with the throughhole in the socket allows use of the device on any length of bolt or all-thread.

### CROSS-REFERENCE TO RELATED APPLICATION

The present application is related to and claims priority from prior provisional application Ser. No. 62/588,289, filed Nov. 17, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of drill adapters and more specifically relates to a drill socket off-set drive assembly.

### 2. Description of the Related Art

Mechanics generally have at least one large toolbox, and most often, have a rollaway toolbox composed of at least two separate large boxes having pull-out drawers. Each drawer is full of tools fitting a certain category that are stored in that drawer. It is debatable when a tool set is complete since there are new tools being designed for different purposes every year. Fasteners on many different types of equipment and mechanical objects are located and positioned in many different ways that have many different degrees of accessibility and therefore many different tools are required in order to tighten or loosen these fasteners. The variations are endless but many of the tools are devoted to a single purpose such as angling a companion tool to conveniently reach and manipulate a fastener, such as right angle drives for use with sockets, wrenches, and screw driver type fastener heads, etc. A single tool is needed that is able to replace a wide variety of other tools and a power drive in order to reduce tool cost, storage space, and labor.

Various attempts have been made to solve the above-mentioned problems such as those found in U.S. Pat. No. 5,863,159 to Leonard J. Lasko; U.S. Pat. No. 6,463,824 to Prell et al.; and U.S. Pat. No. 4,350,064 to James R. Markle. This art is representative of drill adapters. None of the above inventions and patents, taken either singly or in combination, is seen to describe the invention as claimed.

Ideally, a drill adapter should provide reduced storage space, increased versatility, and reduced labor, and, yet would operate reliably and be manufactured at a modest expense. Thus, a need exists for a reliable drill socket off-set drive assembly to avoid the above-mentioned problems.

### BRIEF SUMMARY OF THE INVENTION

In view of the foregoing disadvantages inherent in the known drill adapter art, the present invention provides a novel drill socket off-set drive assembly. The general purpose of the present invention, which will be described subsequently in greater detail, is to provide a reduced storage space, increased versatility, and reduced labor.

A drill socket off-set drive assembly may comprise a gear assembly that includes an outer casing having a rotary socket housing portion forming a hollow cylindrical inner volume defining a linear axis therethrough. The rotary socket housing portion includes a rod aperture therethrough at a bottom portion aligned coaxially with the linear axis. The rotary socket housing portion is designed to retain a rotary socket therein. A gear housing portion includes a first drive shaft cylindrical aperture defining a linear axis that is perpendicular to the linear axis of the rotary socket housing portion, and is adapted to rotatably retain a portion of a first drive shaft therein.

A second drive shaft cylindrical aperture defines a linear axis parallel to the linear axis of the rotary socket housing portion and is adapted to rotatably retain a portion of a second drive shaft therein. A cylindrical rotary gear retaining portion defines a linear axis parallel to the linear axis of the rotary socket housing portion and is adapted to rotatably retain a rotary gear therein. A rotary socket having an elongated hollow cylindrical body includes an inner surface formed having a polygonal cross-section and defines a linear axis therethrough. The rotary socket includes a rod aperture therethrough at a bottom portion that is aligned coaxially with the linear axis.

A series of gear teeth are located around the outer perimeter of the elongated hollow cylindrical body. The rotary socket is located and adapted to rotate within the rotary socket housing portion of the outer casing and is adapted to releasably engage with and rotate a socket member for engaging and rotating mechanical nuts. The rotary gear includes a series of gear teeth located around the outer perimeter that are adapted to interdigitate with the series of gear teeth of the rotary socket to thereby rotate the rotary socket within the rotary socket housing portion. The rotary gear is located and rotatable within the cylindrical rotary gear retaining portion of the gear housing portion.

A first drive shaft includes an elongated shaft that is adapted to pass through and be rotatably retained within the first drive shaft cylindrical aperture. A first drive shaft gear member includes a series of gear teeth located around the outer perimeter thereof and is adapted to interdigitate with the series of gear teeth of the rotary gear to thereby rotate the rotary gear within the cylindrical rotary gear retaining portion. The first drive shaft gear member is connected at a distal end of the elongated shaft and is adapted to be located and rotated within the gear housing portion. The first drive shaft is adapted to be rotated by a drill.

A second drive shaft includes an elongated shaft adapted to pass through and be rotatably retained within the second drive shaft cylindrical aperture. A second drive shaft gear member includes a series of gear teeth located around its outer perimeter that are adapted to interdigitate with the gear teeth of the first drive shaft gear member to thereby rotate the first drive shaft gear member. The second drive shaft gear member is connected at the distal end of the elongated shaft and is adapted to be located and rotated within the gear housing portion. The second drive shaft is adapted to be rotated by a drill.

A socket member is formed having a hollow cylindrical inner volume defining a linear axis therethrough adapted to be aligned coaxially with the linear axis of the rotary socket housing portion. The socket member includes a rod aperture therethrough at the bottom portion adapted to be aligned coaxially with the linear axis of the rotary socket housing portion, and has an inner surface formed having a polygonal cross-section adapted to engage and rotate mechanical nuts upon an elongated threaded rod. The socket member includes an outer surface formed having a polygonal cross-section adapted to interdigitate with the polygonal inner surface of the rotary socket. The socket member is designed to slide over an elongated threaded rod to engage and rotate a mechanical nut.

The rotatable socket of the gear assembly is also adapted to slide over the elongated threaded rod to rotatably engage the socket member such that a drill can either rotate the first drive shaft or the second drive shaft to rotate the mechanical nut upon the elongated threaded rod depending on the accessibility of the elongated threaded rod.

The rotary socket housing portion socket rod aperture, the rotary socket rod aperture, and the socket member rod aperture are each formed having a circular shape adapted to allow an elongated threaded rod having a circular cross-section to pass therethrough. The circular shape of the rotary socket housing portion socket rod aperture, the rotary socket rod aperture, and the socket member rod aperture are congruent. The diameters of the circular shape of the rotary socket housing portion socket rod aperture, the rotary socket rod aperture, and the socket member rod aperture are 1 inch.

The rotary socket housing portion, the first drive shaft cylindrical aperture, the second drive shaft cylindrical aperture, and the cylindrical rotary gear retaining portion each include ball bearings there around adapted to reduce friction between respective rotating parts. The drill socket off-set drive adapter is formed from tool-grade steel. The first drive shaft gear member is connected to the distal end of the elongated shaft of the first drive shaft via a swivel joint, and the second drive shaft gear member is connected to the distal end of the elongated shaft of the second drive shaft via a swivel joint. The first drive shaft and the second first drive shaft are pivotable with respect to their respective gear members. The first drive shaft and the second drive shaft are formed having a width measuring ¼ of an inch. The first drive shaft and the second drive shaft are formed having a width measuring ¾ of an inch.

The drill socket off-set drive adapter is formed having dimensions including 7 inches in length, 2 inches in width, and 2 inches in height. The cylindrical inner volume of the socket member is formed having a diameter between ¼ inch and 2 inches. The cylindrical inner volume of the socket member is formed having a diameter between 1 mm and 110 mm.

The present invention holds significant improvements and serves as a drill socket off-set drive assembly. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a drill adapter Device, constructed and operative according to the teachings of the present invention.

FIG. 1 shows a perspective view illustrating a drill socket off-set drive assembly according to an embodiment of the present invention.

FIG. 2 is a perspective view illustrating a drill socket off-set drive assembly with the rotary socket separated from the rotary socket housing portion according to an embodiment of the present invention of FIG. 1.

FIG. 3 is a see-through view illustrating the rotary socket housing portion of the drill socket off-set drive assembly according to an embodiment of the present invention of FIG. 1.

FIG. 4 is a perspective view illustrating a shaft lock of the drill socket off-set drive assembly according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a drill adapter and more particularly to a drill socket off-set drive assembly as used to improve the reduced storage space, increased versatility, and reduced labor.

Generally speaking, the drill socket off-set drive assembly is an adapter for use in an electric drill that provides a right angle drive and an offset drive in one unit that is adapted to use various sized sockets for use on hexagonal fastener heads. A throughhole in the housing aligning with the throughhole in the socket allows use of the device on any length of bolt or all-thread.

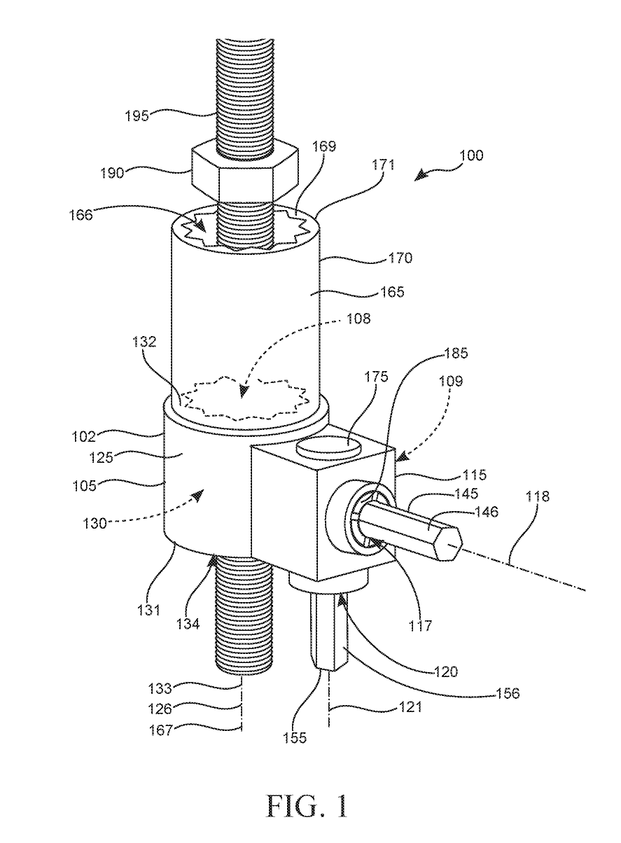

Referring to the drawings by numerals of reference there is shown in FIG. 1, a perspective view illustrating drill socket off-set drive assembly 100 according to an embodiment of the present invention.

Drill socket off-set drive assembly 100 may comprise gear assembly 109 that includes outer casing 102 having rotary socket housing portion 105 forming hollow cylindrical inner volume 106 defining linear axis 107 therethrough. Rotary socket housing portion 105 includes rod aperture 108 therethrough at a bottom portion aligned coaxially with linear axis 107. Rotary socket housing portion 105 is designed to retain rotary socket 130 therein. Gear housing portion 115 includes first drive shaft cylindrical aperture 117 defining linear axis perpendicular 118 at a 90 degree angle to linear axis parallel 121 of rotary socket housing portion 105, and is adapted to rotatably retain a portion of first drive shaft 145 therein.

second drive shaft cylindrical aperture 120 defines linear axis parallel 121 of rotary socket housing portion 105 and is adapted to rotatably retain a portion of second drive shaft 155. cylindrical rotary gear retaining portion 125 defines linear axis parallel 126 to the axis of rotary socket housing portion 105 and is adapted to rotatably retain rotary gear 140 therein.

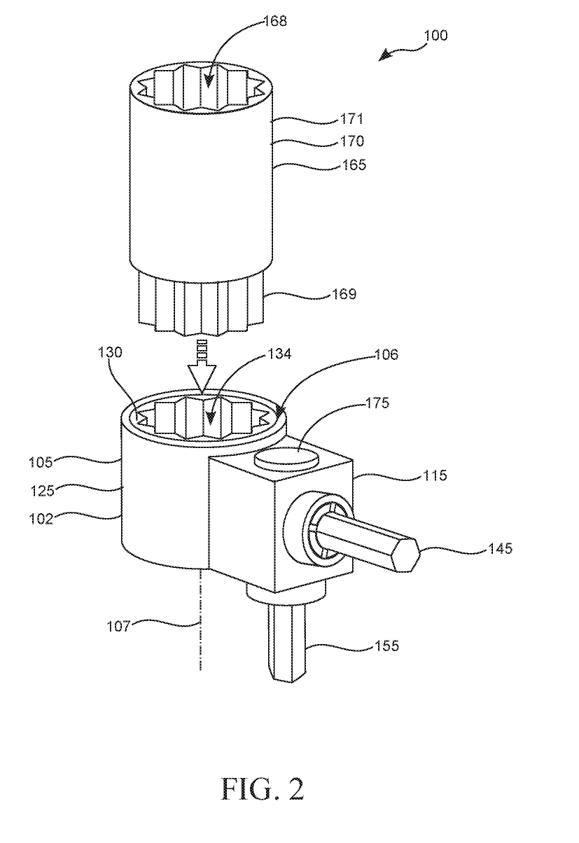

Referring now to FIG. 2, is a perspective view illustrating drill socket off-set drive assembly 100 with socket member 165 separated from rotary socket housing portion 105 according to an embodiment of the present invention of FIG. 1.

Rotary socket 130 having elongated hollow cylindrical body 131 includes an inner surface formed having polygonal cross-section 132 and defines linear axis 133 therethrough. Rotary socket 130 includes rod aperture 134 therethrough at the bottom portion that is aligned coaxially with linear axis 133. Socket member 165 is formed having hollow cylindrical inner volume 166 defining linear axis 167 therethrough adapted to be aligned coaxially with linear axis 107 of rotary socket housing portion 105. Socket member 165 includes rod aperture 168 therethrough at the bottom portion adapted to be aligned coaxially with linear axis 107 of rotary socket housing portion 105, and has an inner surface formed having polygonal cross-section 169 adapted to engage and rotate mechanical nut 190 upon elongated threaded rod 195. Socket member 165 includes an outer surface formed having polygonal cross-section 169 adapted to interdigitate with the polygonal inner surface of rotary socket 130. Socket member 165 is designed to slide over elongated threaded rod 195 to engage and rotate mechanical nut 190.

Rotary socket 130 of gear assembly 109 is also adapted to slide over elongated threaded rod 195 to rotatably engage socket member 165 such that a drill can either rotate first drive shaft 145 or second drive shaft 155 to rotate mechanical nut 190 upon elongated threaded rod 195 depending on the accessibility of elongated threaded rod 195.

Rod aperture 168 of socket member 165 of rotary socket housing portion 105, rod aperture 134 of rotary socket 130, and rod aperture 168 of socket member 165 are each formed having circular shape 171 adapted to allow elongated threaded rod 195 having a circular cross-section to pass therethrough. Circular shape 171 of rod aperture 168 of rotary socket housing portion 105, rod aperture 134 of rotary socket 130, and rod aperture 168 of socket member 165 are congruent. The diameters of circular shape 171 of rod aperture 108 of rotary socket housing portion 105, rotary socket 130 rod aperture 134, and socket member 165 rod aperture 168 are 1 inch.

Drill socket off-set drive assembly 100 is formed having dimensions including 7 inches in length, 2 inches in width, and 2 inches in height. Hollow cylindrical inner volume 166 of socket member 165 is formed having a diameter between ¼ inch and 2 inches or of between 1 mm and 110 mm in metric version.

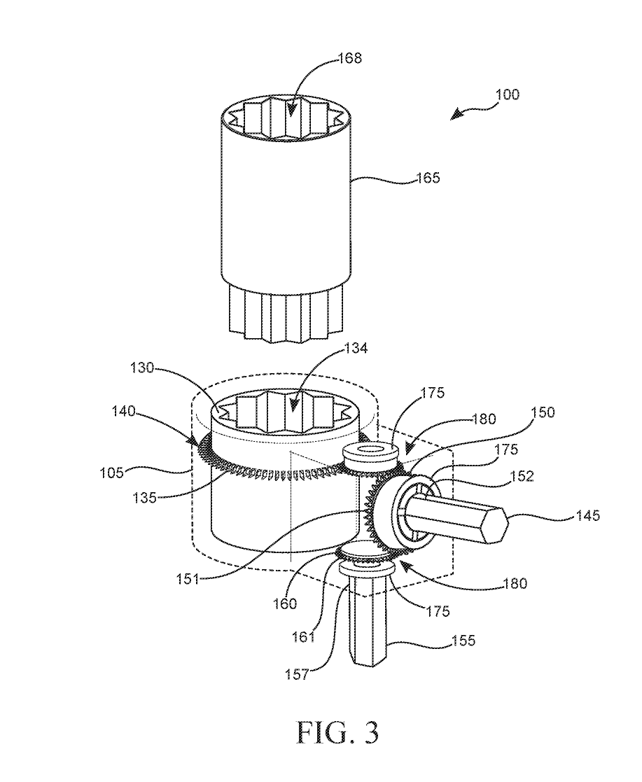

Referring now to FIG. 3, is a see-through view illustrating rotary socket housing portion 105 of drill socket off-set drive assembly 100 according to an embodiment of the present invention of FIG. 1.

A series of gear teeth 141 are located around the outer perimeter of elongated hollow cylindrical body 131 of rotary socket 130. Rotary socket 130 is located and adapted to rotate within rotary socket housing portion 105 of outer casing 102 and is adapted to releasably engage with and rotate socket member 165 for engaging and rotating mechanical nut 190. Rotary gear 140 includes a series of gear teeth 141 located around the outer perimeter that are adapted to interdigitate with the series of gear teeth 141 of rotary socket 130 to thereby rotate rotary socket 130 within rotary socket housing portion 105. Rotary gear 140 is located and rotatable within cylindrical rotary gear retaining portion 125 of gear housing portion 115.

First drive shaft 145 includes elongated shaft 146 that is adapted to pass through and be rotatably retained within first drive shaft cylindrical aperture 117. First drive shaft gear member 150 includes a series of gear teeth 141 located around the outer perimeter thereof and is adapted to interdigitate with the series of gear teeth 141 of rotary gear 140 to thereby rotate rotary gear 140 within cylindrical rotary gear retaining portion 125. First drive shaft gear member 150 is connected at distal end 152 of elongated shaft 146 and is adapted to be located and rotated within gear housing portion 115. First drive shaft 145 is adapted to be rotated by a drill.

Second drive shaft 155 includes elongated shaft 156 adapted to pass through and be rotatably retained within second drive shaft cylindrical aperture 120. Second drive shaft gear member 160 includes a series of gear teeth 141 located around its outer perimeter that are adapted to interdigitate with gear teeth 141 of first drive shaft gear member 150 to thereby rotate first drive shaft gear member 150. Second drive shaft gear member 160 is connected at distal end 157 of elongated shaft 156 and is adapted to be located and rotated within gear housing portion 115. Second drive shaft 155 is adapted to be rotated by a drill.

Rotary socket housing portion 105, first drive shaft cylindrical aperture 117, second drive shaft cylindrical aperture 120, and cylindrical rotary gear retaining portion 125 each include ball bearings 175 there around adapted to reduce friction between respective rotating parts. Drill socket off-set drive assembly 100 is formed from tool-grade steel. First drive shaft gear member 150 is connected to distal end 152 of elongated shaft 146 of first drive shaft 145 via swivel joint 180, and second drive shaft gear member 160 is connected to distal end 157 of elongated shaft 156 of second drive shaft 155 via swivel joint 180. First drive shaft 145 and second drive shaft 155 are pivotable with respect to their respective rotary gears 140. First drive shaft 145 and second drive shaft 155 may be formed having a width measuring anywhere between ¼ of an inch and ¾ of an inch.

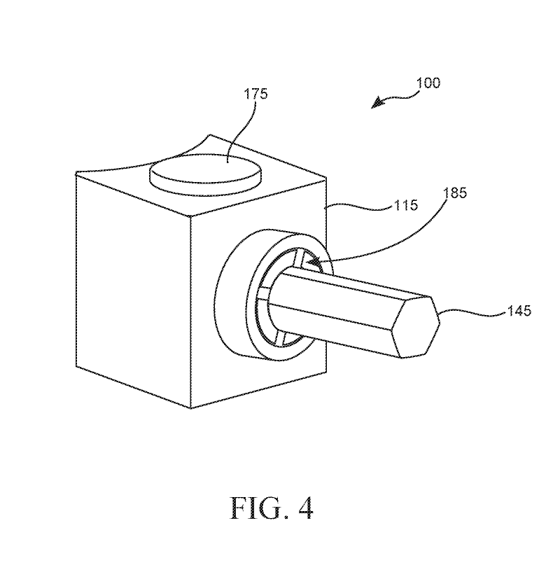

Referring now to FIG. 4, showing a perspective view illustrating shaft lock 185 of drill socket off-set drive assembly 100 according to an embodiment of the present invention of FIG. 1.

Shaft lock 185 is located on outer casing 102 and has a raised cylindrical portion that the user can grip between the thumb and forefinger to pull out and rotate in order to lock the shaft or to unlock the shaft by pulling outward and rotating the collar in the reverse direction.

Drill socket off-set drive assembly 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., specific kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A drill socket off-set drive assembly comprising:
a gear assembly including:
an outer casing including:
a rotary socket housing portion;
wherein said rotary socket housing portion forms a hollow cylindrical inner volume defining a linear axis therethrough; and
wherein said rotary socket housing portion includes a rod aperture therethrough at a bottom portion thereof and aligned coaxially with said linear axis;
wherein said rotary socket housing portion is adapted to retain a rotary socket therein;
a gear housing portion including:
a first drive shaft cylindrical aperture;
wherein said first drive shaft cylindrical aperture defines a linear axis perpendicular to said linear axis of said rotary socket housing portion, and is adapted to rotatably retain a portion of a first drive shaft therein;
a second drive shaft cylindrical aperture;
wherein said second drive shaft cylindrical aperture defines a linear axis parallel to said linear axis of said rotary socket housing portion, and is adapted to rotatably retain a portion of a second drive shaft therein; and
a cylindrical rotary gear retaining portion;
wherein said cylindrical rotary gear retaining portion defines a linear axis parallel to said linear axis of said rotary socket housing portion, and is adapted to rotatably retain a rotary gear therein;
a rotary socket including:
an elongated hollow cylindrical body;
wherein said elongated hollow cylindrical body includes an inner surface formed having a polygonal cross-section and defines a linear axis therethrough; and
wherein said rotary socket includes a rod aperture therethrough at a bottom portion thereof and aligned coaxially with said linear axis;
a series of gear teeth;
wherein said series of gear teeth are located around an outer perimeter of said elongated hollow cylindrical body;
wherein said rotary socket is located and adapted to rotate within said rotary socket housing portion of said outer casing; and
wherein said rotary socket is adapted to releasably engage with and rotate a socket member for engaging and rotating mechanical nuts;
a rotary gear including:
a series of gear teeth located around an outer perimeter thereof and adapted to interdigitate with said series of gear teeth of said rotary socket to thereby rotate said rotary socket within said rotary socket housing portion; and
wherein said rotary gear is located and rotatable within said cylindrical rotary gear retaining portion of said gear housing portion;
a first drive shaft including:
an elongated shaft;
wherein said elongated shaft is adapted to pass through an be rotatably retained within said first drive shaft cylindrical aperture; and
a first drive shaft gear member including:
a series of gear teeth located around an outer perimeter thereof and adapted to interdigitate with said series of gear teeth of said rotary gear to thereby rotate said rotary gear within said cylindrical rotary gear retaining portion; and
wherein said first drive shaft gear member is connected at a distal end of said elongated shaft and is adapted to be located and rotated within said gear housing portion;
wherein said first drive shaft is adapted to be rotated by a drill;
a second drive shaft including:
an elongated shaft;
wherein said elongated shaft is adapted to pass through an be rotatably retained within said second drive shaft cylindrical aperture; and
a second drive shaft gear member including:
a series of gear teeth located around an outer perimeter thereof and adapted to interdigitate with said series of gear teeth of first drive shaft gear member to thereby rotate said first drive shaft gear member; and
wherein said second drive shaft gear member is connected at a distal end of said elongated shaft and is adapted to be located and rotated within said gear housing portion;
wherein said second drive shaft is adapted to be rotated by a drill; and
a socket member;
wherein said socket member is formed having a hollow cylindrical inner volume defining a linear axis therethrough adapted to be aligned coaxially with said linear axis of said rotary socket housing portion;
wherein said socket member includes a rod aperture therethrough at a bottom portion thereof and adapted to be aligned coaxially with said linear axis of said rotary socket housing portion;
wherein said socket member includes an inner surface formed having a polygonal cross-section adapted to engage and rotate mechanical nuts upon an elongated threaded rod; and
wherein said socket member includes an outer surface formed having a polygonal cross-section adapted to interdigitate with said polygonal inner surface of said rotary socket;
wherein said socket member is adapted to slide over an elongated threaded rod to engage and rotate a mechanical nut thereon, and wherein said rotatable socket of said gear assembly is adapted to slide over said elongated threaded rod to rotatably engage said socket member, such that a drill can either rotate said first drive shaft or said second drive shaft to rotate said mechanical nut upon said elongated threaded rod depending on the accessibility of said elongated threaded rod.

2. The drill socket off-set drive adapter of claim 1, wherein said rotary socket housing portion socket rod aperture, said rotary socket rod aperture, and said socket member rod aperture are each formed having a circular shape adapted to allow an elongated threaded rod having a circular cross-section to pass therethrough.

3. The drill socket off-set drive adapter of claim 2, wherein said circular shape of said rotary socket housing portion socket rod aperture, said rotary socket rod aperture, and said socket member rod aperture are congruent.

4. The drill socket off-set drive adapter of claim 3, wherein said diameters of said circular shape of said rotary socket housing portion socket rod aperture, said rotary socket rod aperture, and said socket member rod aperture are 1 inch.

5. The drill socket off-set drive adapter of claim 1, wherein said rotary socket housing portion, said first drive shaft cylindrical aperture, said second drive shaft cylindrical aperture, and said cylindrical rotary gear retaining portion each include ball bearings there around adapted to reduce friction between respective rotating parts.

6. The drill socket off-set drive adapter of claim 1, wherein said drill socket off-set drive adapter is formed from tool-grade steel.

7. The drill socket off-set drive adapter of claim 1, wherein said first drive shaft gear member is connected to said distal end said elongated shaft of said first drive shaft via a swivel joint; and said second drive shaft gear member is connected to said distal end of said elongated shaft of said second drive shaft via a swivel joint; wherein said first drive shaft and second first drive shaft are pivotable with respect to their respective gear members.

8. The drill socket off-set drive adapter of claim 1, wherein said first drive shaft and said second drive shaft are formed having a width measuring ¼ of an inch.

9. The drill socket off-set drive adapter of claim 1, wherein said first drive shaft and said second drive shaft are formed having a width measuring ¾ of an inch.

10. The drill socket off-set drive adapter of claim 1, wherein said drill socket off-set drive adapter is formed having dimensions including 7 inches in length, 2 inches in width, and 2 inches in height.

11. The drill socket off-set drive adapter of claim 1, wherein said cylindrical inner volume of said socket member is formed having a diameter between ¼ inch and 2 inches.

12. The drill socket off-set drive adapter of claim 1, wherein said cylindrical inner volume of said socket member is formed having a diameter between 1 mm and 110 mm.
